(19) United States
(12) Patent Application Publication
(10) Pub. No.: US 2018/0204370 A1
(43) Pub. Date: Jul. 19, 2018

(54) Passenger Avatar for Display on Shared Vehicles

(71) Applicant: Christopher Kenneth Hoover Wilson, Redwood City, CA (US)

(72) Inventor: Christopher Kenneth Hoover Wilson, Redwood City, CA (US)

(21) Appl. No.: 15/874,576

(22) Filed: Jan. 18, 2018

Related U.S. Application Data
(60) Provisional application No. 62/448,001, filed on Jan. 19, 2017.

(51) Int. Cl. G06T 13/80; G06F 21/31; G06F 17/30; B60Q 1/50

(52) U.S. Cl. CPC G06T 13/80; B60Q 1/50; G06F 17/30203; G06F 21/31

(57) ABSTRACT

A system and method for a vehicle to display to observers in proximity to said vehicle information indicative of or chosen by the occupant or person otherwise associated with said vehicle. This information may be any form and constitutes the avatar for said occupant or person. The avatar is displayed as a statement of identity, individuality or personal expression that personalizes a vehicle in a reconfigurable manner. This is particularly applicable to shared vehicles enabling them to provide a display related to a specific occupant or associated person.

### CROSS-REFERENCE TO RELATED APPLICATIONS

This application is following provisional patent application #62448001 having the same title and inventor and filed on 19 Jan. 2017.

### BACKGROUND OF THE INVENTION

Personal vehicles are generally purchased and outfitted, in part, as a statement of identity, rather than simply a utilitarian device. The color, style, racks, and content strewn about the interior reflect an individual's preferred image and lifestyle. This is supported by the currently typical one-to-one association between vehicles and individuals, which is not the case in a car sharing environment. The association of individuals with vehicles is particularly problematic for shared automated vehicles which are likely to be purchased and owned by corporations which will purchase vehicles for both utilitarian reasons and to appeal to certain large categories of riders. Vehicles are likely to appear very similar to one another. Vehicle sharing reduces the ability of individuals to project their own self-image with the vehicles they choose to purchase or ride in. Automation implies there is no driver to provide personalization, or prohibit others from doing so, providing an opportunity for self-expression. This invention allows for individuals to express individuality through the vehicle they are using while also enabling sharing of generic vehicles through a shared vehicle which can be automatically configured for each individual in a manner obvious to observers near the vehicle. The vehicle is then automatically reconfigured for the next individual using the vehicle, allowing them to express their individuality.

### DESCRIPTION OF THE PRIOR ART

Flags attached to a vehicle, generally in the front corners of a vehicle, indicate a particular individual inside. The flag may be the flag of a country and it indicates the presence of an ambassador or other official. These systems indicate to bystanders the presence of an individual, but the display is not changed automatically, and cannot be reconfigured to represent multiple individuals as described in this disclosure. Similarly, bumper stickers, plastic wraps, magnetized signs, sports team pennants, and “Rudolph” noses around Christmas time provide individualization for vehicles, but these are not electronically reconfigurable and are generally not associated with shared vehicles, or the individuals using a shared vehicle.

Electronically reconfigurable advertising has been used on buses trailers, and the roofs of vehicles. The advertising shown is determined under commercial terms and for commercial reasons and does not reflect on the occupants of the vehicle. These sorts of displays are generally not configurable by the occupants of the vehicle, or if they are configurable are specified in a contract and not motivated by the occupant nor would they be considered indicative of the occupant or associated individual by observers. Electronically configurable destination signs for buses are also in use. These are not selected by the occupants of the bus and do not convey information about individuals associated with the bus as required by this disclosure.

Waze and other internet services make use of avatars to represent drivers of vehicles, but these are not generally apparent or available to observers in the vicinity of the vehicle and are not associated with the vehicle but rather are associated with an application generally running on a mobile device.

U.S. Pat. No. 9,494,938 to Kemler, incorporated by reference, describes a system for “unique signaling for autonomous vehicles to preserve user privacy”. Many users do desire privacy, and the Kemler patent specifically calls for anonymity and that the display not reflect the identity of the user. The “signaling” is generated algorithmically and must not identify the person it signals, and is used only to associate a vehicle with the user when picking up the user. The current invention addresses a different type of user who seeks recognition or distinction, or at least wishes to make a statement about their taste or mood. This invention utilizes a display of an “avatar” to reflect a particular user towards people external to the vehicle, both while picking up and transporting the user.

The practice of using a key fob to flash the lights and honk the horn of a car to identify the car in a parking light is well known, but this requires the searching individual to have the physical key fob, and the displays are in no way unique to an individual.

Configuring the interior of cars to reflect the driver's needs is well known in the art. Seat position, display characteristics, and radio settings are commonly associated with particular key fobs, and may be maintained in a profile maintained remotely by the vehicle manufacturer. These are not generally apparent outside the vehicle and are not configured to reflect the particular driver or passengers.

### BRIEF SUMMARY OF THE INVENTION

This invention provides a method and system for a vehicle to signal characteristics indicative of a particular individual or chosen by that individual to persons or sensors encountering the vehicle. The invention consists of a number of display devices associated with the vehicle that can be reconfigured automatically based on user preferences either entered explicitly or associated with that user via an identification scheme and previous interactions. Display devices consist of any visible, audible, or otherwise sensable characteristic that can be detected by humans or sensors either directly or indirectly. These displays provide a unique signal or look to a vehicle, functions performed today by selections of design, color, personalized painting, license plate holders, bumper stickers, fuzzy dice, cleanliness, and the like. This allows a particular vehicle to be identified among otherwise identical vehicles (especially those without drivers), as well as the personality or mood of the user to be expressed to those sensing the vehicle. In this disclosure, these signals displayed will be referred to as an individual's “avatar”, the individual being the person associated with the vehicle by observers of the vehicle. An individual may have a persistent avatar, or may choose one on the spur of the moment to reflect transitory interests of the individual. An avatar may also be associated with multiple individuals associated with a vehicle, and even goods transported by the vehicle.

An avatar may be a simple signal shared by many individuals, such as 5 red lights on the roof of a vehicle in a “crown”. The avatar may also be a very sophisticated display, such as a horse displayed on the side of the vehicle galloping at a speed corresponding to the speed of the car and complete with the sound of hoofbeats. The avatar may also respond to the presence of other objects and observers, such as cars or pedestrians, especially where individuals can be uniquely identified. “Observers” in this context includes any sensory modality such as visual or auditory, as well as electronic sensing, such as traffic cameras.

One novel aspect of this invention is that persons or objects near a vehicle perceive configurable information associated with the particular vehicle, that information containing content associated with a person associated with that vehicle. While the preferred embodiment is for shared vehicles, in particular those without drivers, and allows sequential users to easily display their own avatars, the system may also be used by individually owned vehicles that are not shared.

### BRIEF DESCRIPTION OF THE DRAWINGS

FIG. 1 is an overview of the components described in the disclosure.

FIG. 2 is a flow diagram of one embodiment of the disclosure.

FIG. 3 illustrates a display consistent with various embodiments of the disclosure.

FIG. 4 illustrates a display consistent with various embodiments of the disclosure.

FIG. 5 illustrates a display consistent with various embodiments of the disclosure.

FIG. 6 illustrates a display consistent with various embodiments of the disclosure.

### DETAILED DESCRIPTION OF THE INVENTION

### Avatar Selection

In the context of this disclosure, an avatar is signaling information associated with a particular individual, particular group of individuals, or set of goods. An avatar is any perceivable display chosen by an individual to represent themselves to others. Like the clothing we choose to represent ourselves on any given day, individuals may have a unique avatar or several different avatars representing different moods, vehicles, environments or situations. An avatar may be a pattern unique to an individual, possibly conveying data that uniquely identifies an occupant. The avatar may also simply be an artistic expression, an expression of an individual's skill at building avatars, or avatars may be selected from a catalog to appeal to an individual's tastes. The meaning of the avatar, or the motivation for a particular avatar need not be apparent to others. An avatar, as used in this application, is a means for individual expression or identification for someone using a commonplace vehicle, said vehicle possibly being shared.

Individuals may have different avatars for display in association with a vehicle, as described in this patent, and for display in association with other electronic systems such a games and social media, or those avatars may be related or identical.

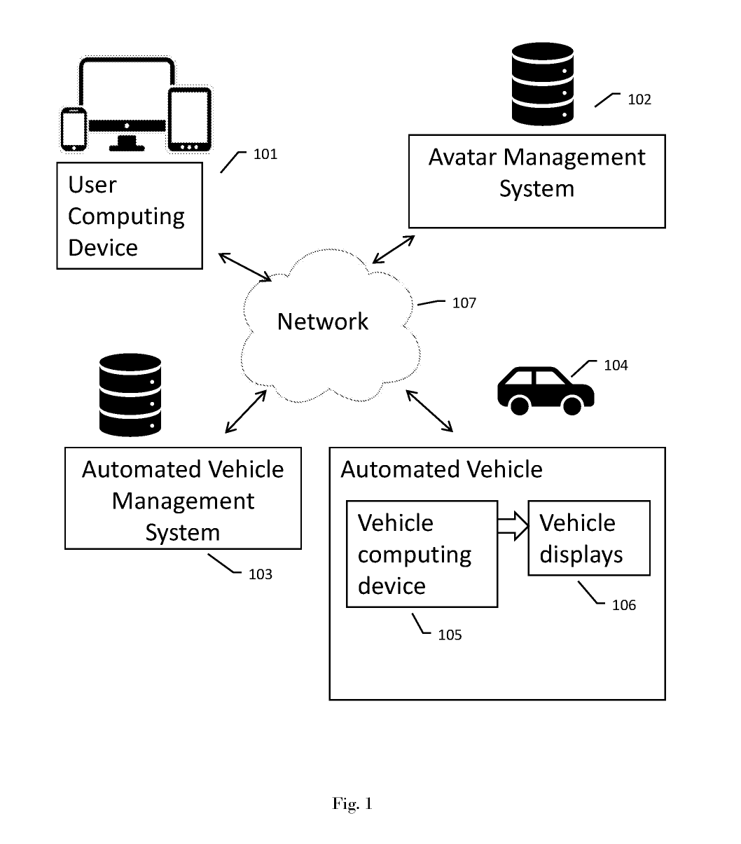

FIG. 1 shows a general description of the invention. Several computer systems are connected a network. The user computing device 101 is a device that an individual uses to select or create an avatar using resources on the user computing device and optionally other design resources (not shown) connected through the network 107. Design resources include, among others, paint programs to build a two dimensional avatar, or a CAD modeling program for a three dimensional avatar, or any system suitable for building video, imagery or other media that can be displayed on the vehicle display devices as described below. Pre-made avatars may also be selected from libraries. Once an avatar is chosen, this is stored in an avatar management system 102 that provides a repository of avatars associated with individuals, and optionally avatar design patterns. The avatar management system may reside within the user computing device 101, or may be a standalone system.

A user requests a transportation service by contacting the automated vehicle management system 103 which managed the dispatch of automated vehicles. As part of the transaction of obtaining the transportation service, the user provides the transportation service 103 or the vehicle 104 directly the avatar description, or the identity of the avatar as stored in the avatar management system 102. In one embodiment the vehicle is dispatched independent of the avatar characteristics, in a second embodiment the vehicle to be dispatched is chosen based, in part, on the availability of suitable displays 106 for the particular avatar. In the preferred embodiment, the avatar management system 102 is provided with information on the vehicle displays 106 and tailors or approximates the avatar to the specific displays available on the dispatched vehicle 104, or selects the optimum vehicle from among those available. In other embodiments approximation of the avatar for the particular displays can be done in the vehicle computing device 105, by the automated vehicle management system 103, or elsewhere in the network 107 (not shown). Matching descriptions or models to various displays is performed using techniques known to those skilled in the art.

The sequence of events leading up to the display of an avatar is shown in FIG. 2. In 201 the user requests transportation from an automated transportation service. The user may provide the identity of the avatar they want to use 203 as part of the ordering process (reversing the order with 202 as shown in the figure), in which case it may be used in the selection of a vehicle to dispatch 202. The vehicle may be dispatched independently of the identification of the avatar, and the avatar identity provided separately as shown in FIG. 2.

In the preferred embodiment, as the vehicle approaches the pickup location where the vehicle is to be identified by the user, it displays the avatar for ease of identification 204. In some embodiments the avatar is not provided to the vehicle over the network 107 and must be provided to the vehicle 104 directly by the user, either through a file containing the avatar description (from the avatar management system 102), or through an interface in the vehicle that allows the user to identify and create an avatar on the spot. Once an avatar is provided, the avatar is displayed on the vehicle at step 204. The user may choose a different avatar and update the display 205, and this new avatar may be sent to the avatar management system 102 for future use 206. At the conclusion of the transportation service, the user's avatar is removed 207 and the next user's avatar may be displayed.

The capabilities of vehicles to display avatars will evolve. In the near-term, displays may be limited to fixed lights and electronic displays such as LCD, LED, OLED or other commonly used screen technologies. In one embodiment an avatar may be a configuration of fixed lights on the roof of a vehicle, the pattern of lights that are illuminated representing an individual. In a second embodiment a two-dimensional display on the side of a vehicle may show an avatar such as a tartan, flag, quotation, image of the occupant, or an avatar used on social media. In another embodiment the avatar might be a moving image of a horse on the side of the vehicle galloping at a speed proportional to the speed of the vehicle. The vehicle also emitting sounds corresponding to the galloping horse. The horse might further interact with other vehicles and persons, looking at them or shying away. The display may vary depending on lighting or other environmental conditions.

Avatars may interact with observers. An avatar might inform others of the intended movements of the vehicle, either through visual or auditory indications. An avatar may elicit a connection with observers in the context of a social or dating app or capturing data regarding some event such as a crash. The environment and the presence and relative locations of other observers may be determined from vehicle sensors and provided to the avatar display system to configure the display appropriately for said environment or observers.

When an automated vehicle is picking up a user and comes into proximity of the user, the avatar may have a particular ‘hello’ display when the user is detected by the vehicle's sensors, or when the user's location is known through various location services well known to those knowledgeable in the field. A similar display may be enabled for when the user leaves the vehicle, a ‘goodbye’ display.

Different avatars will correspond to different display capabilities available in the vehicle, and avatars may be modified or approximated to reflect display capabilities. As an example, if one's avatar is a Viking helmet with horns, this may be represented as two lights on the roof of the vehicle, a picture of a Viking helmet on the side of the vehicle, a holograph of horns above the vehicle, or three-dimensional reconfigurable protuberances from the vehicle with a likeness to horns.

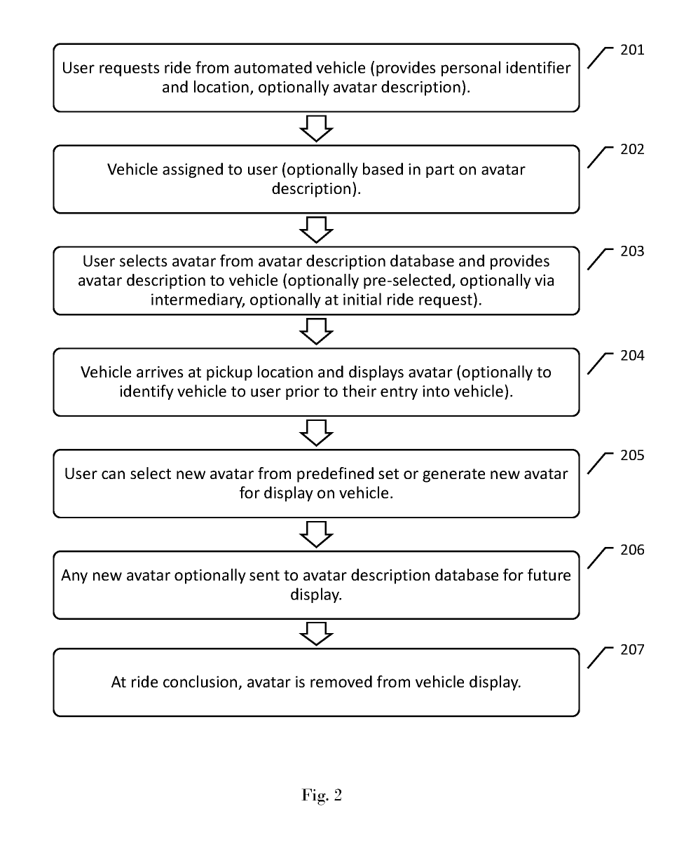

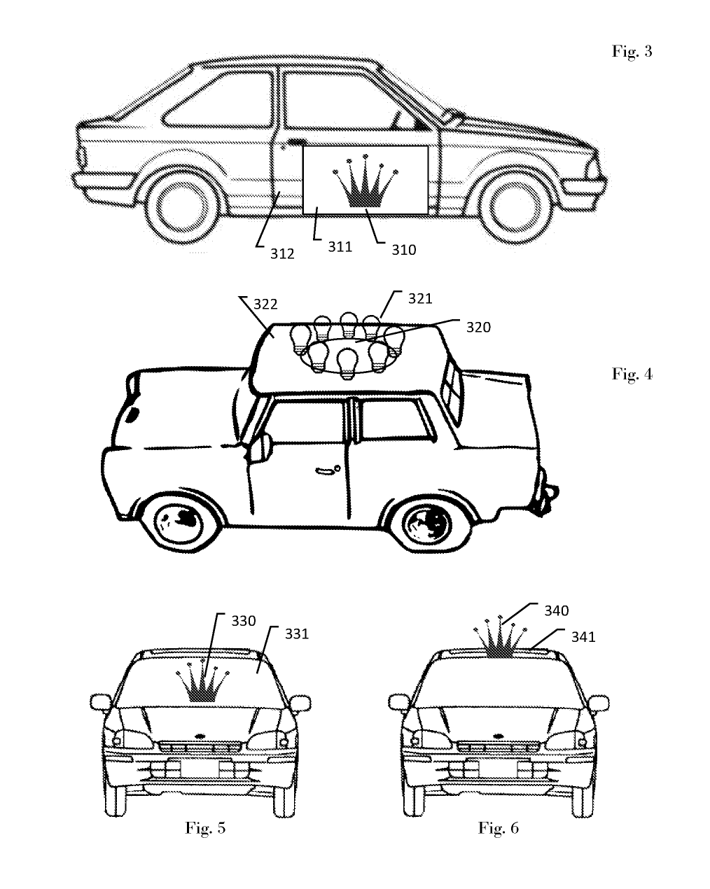

FIGS. 3-6 illustrate several embodiments of a “crown” avatar in vehicle with different types of displays 106. FIG. 3 shows a crown 310 displayed on a screen 311 attached to a door of a car 312. This screen can be of any type commonly used for displaying images and is known in the art. This can also display moving images as described above. FIG. 3 illustrates the screen as flat, in the preferred embodiment the screen is conformal with the surface of the vehicle. FIG. 4 shows a crown 320 represented as lights 321 on the roof of a car 322. Incandescent bulbs are indicated in the figure, 321, but LED lights are the preferred embodiment. The arrangement and number of the lights and the colors can be changed to support different displays and avatars. FIGS. 5 and 6 show more futuristic displays. Crown 330 is displayed on the windshield 331 through an electrochromic display. Crown 340 above the roof 341 may be a holographic or mechanical display.

### Display Modalities

Display, in the context of this disclosure, has the general meaning of “allow others to perceive” there is no limitation to any particular human or machine sense.

Examples of display modalities include lighting, color changes to the surfaces of the vehicle, patterns on the vehicle surface, holographic projections around the vehicle, light projections onto surfaces adjacent to the vehicle or onto the roadway, and mechanical modifications to the vehicle surface. This invention also envisions displays that are only apparent with the use of some apparatus such as augmented reality display, or possibly projection onto the screens of other vehicles and apparently overlaid to other drivers or traffic monitoring systems. In these cases, the avatar information is provided to viewers via a datalink, possibly in conjunction with various cloud services. As an illustrative example, an augmented reality version of the Waze app might display another user's Waze avatar associated with their vehicle. Other display modalities are also possible and will be obvious to those familiar with the art.

In one embodiment this invention multicolor LEDs are embedded in the vehicle at a location or locations that are widely visible and the selection of specific LEDs and the color of those LEDs reflects an individual's avatar. The LEDs, or other light sources, may also be spaced closely together, such as in a TV screen, allowing for the projection of 2-D figures, possibly with motion. These two-dimensional light-emitting services may be localized or covering the entire surface of the vehicle. In another embodiment the vehicle or part of the vehicle is coated in an electronic paint that can change reflectivity or color. The patterns electronically impressed into this paint may reflect an individual's avatar. In another embodiment the glass surfaces of the vehicle are made of an electrically sensitive glass that changes opacity that may be used to reflect an individual's avatar. Various colors and patterns may also be electronically impressed into the glass. In another embodiment the vehicle projects holographic images either interior or exterior to the vehicle that are indicative or characteristic of an individual's avatar. In another embodiment the vehicle uses lasers or other optical sources to project light onto the roadway adjacent to the vehicle, or onto other surfaces near the vehicle, such as a ceiling above the vehicle. The patterns projected being characteristic of the individual's avatar. In still another embodiment mechanical modifications may be made to the surface of the vehicle to add projections or indentations such as horns or antennas. These could be implemented either by extending or retracting predesigned features, much like electric antennas used in cars and 80s, the extent of the extension reflecting an individual's avatar. This could also be implemented by having a flexible surface and actuators underneath that surface able to impress a 3-D pattern into the surface. Another embodiment has the vehicle projecting a sound indicative or characteristic of the individual's avatar. These embodiments represent a subset of those envisioned and may be used individually or in combination. Other embodiments of the display will be obvious to those familiar with the art.

If multiple individuals are associated with a particular vehicle, the net display may consist of a combination of avatars from each of the individual contributors. This is an additional feature that may enhance social interaction around this technology. Many methods for combining individual avatars to create a combined avatar are envisioned, the combined avatar is also an embodiment of this patent.

### Avatar Display

When an individual encounters a vehicle suitable for displaying an avatar, or parts thereof, the avatar may be entered explicitly, or may be made available from an avatar description previously developed and stored in an avatar management system with a unique identity code. The identity code may be associated with any feature uniquely identifiable to the individual. Examples of such features include, but are not limited to, a key fob, cell phone, a user ID, an account number, facial recognition and so forth. The avatar may be stored in electronic form within the feature where appropriate, or may be linked to that feature through a unique id referencing the avatar management system either in the vehicle or accessed from remote servers.

Avatars may also be generated, modified, and manipulated in real time to reflect the emotional or intellectual status of an individual, and may be responsive to environmental conditions, such as the proximity of other vehicles, the location of the vehicle, the proximity of known people, or certain driving and traffic situations.

Use of these avatars as identifying insignia when accessing the vehicle as part of a vehicle rental or ride sharing program where no driver or attendant is present will assist in identifying a particular vehicle assigned to an individual. The individual can identify his own vehicle in a parking lot full of similar vehicles or, if automated, as it arrives.

### Avatar as a Security Token

The preferred embodiments of this invention display information selected by individuals according to their own whims and preferences. Other embodiments display information characteristic of those individuals associated with a vehicle (generally passengers), such as their permission to access certain areas, like a garage, parking structure, or military base or licensing information such as the ability of the occupant to drive the vehicle if the automation systems should fail, or other licensing identification. Today implementing these systems generally requires identifying the unique individual inside the vehicle by opening a window and visual inspection or the passing of some credential. Alternatively, a vehicle itself can have privileges identified by the marking or a tag affixed to the vehicle itself. In this situation the vehicle itself must be secured and the occupants managed by some additional security system.

The use of a certified avatar improves on the prior art since it allows the identity of an occupant to be transferred to the exterior of the vehicle and made available for external inspection. The transferred information can be a biometric marker, the presence of an object in the possession of an individual or simply a code known or possessed by a specific individual. One embodiment is to display a signature associated with a public key for an individual in a manner well known to those in the cryptographic field. These embodiments transfer some characteristic of the individual inside the vehicle to the exterior of the vehicle for easier access by people and systems exterior to the vehicle. This might be in the form of a QR code or other machine readable display on the exterior of a vehicle. Preferably a visual avatar is in a standardized location, such as the license plate area, a side window or corner of the windshield to aid in automation. Alternatively, the avatar may be displayed through radio frequency methods well known to those skilled in the art. This embodiment requires the ability to reliably identify individuals and to display certifiable data. These security techniques are well known to those familiar with the art and include such systems as biometric scans and QR codes encrypted with the time and an ID unique to the person identified. Any of these techniques are hereby incorporated in this disclosure.

While the examples used herein generally consider a vehicle to be a car, no such limitation is inherent to this application. Vehicles include cars, buses, trucks, bicycles, trailers, wagons or any other vehicle for use for transportation, especially those that may be shared.

While the various embodiments are intended especially for shared vehicle, it is understood that many individually owned and/or operated vehicles may also employ the described invention because of the enhanced opportunity for self-expression and this is included within the scope of this invention.

While this invention is intended to enable individual expression, it is understood that some individuals may choose to advertise as a form of expression in return from some compensation, possibly consisting of, but not limited to, a reduction in travel costs. The use of advertising or the choosing of avatars based on remuneration is within the scope of this invention.

While various embodiments, including the preferred embodiment, of the invention has been illustrated and described, it will be appreciated that various changes can be made therein without departing from the spirit and scope of the invention.

The embodiments of the invention in which an exclusive property or privilege is claimed are defined as follows:

1. A method comprising:
one or more processors in an automated vehicle receiving instructions to proceed to a location in response to a request by a user for transport of people or goods;
one or more processors in said automated vehicle receiving a data file containing the description of an avatar associated with said user, said people, or said goods;
said data file having been created or identified by said user;
in response to said description of an avatar, one or more processors in a vehicle causing said avatar, or an approximation thereof based on the available display devices, to be displayed on or about the vehicle in a manner visible to persons external to the vehicle.

2. The method of claim 1 where the avatar consists of a two dimensional image and the display devices consist of two dimensional displays.

3. The method of claim 1 where the data file containing the description of an avatar is obtained from a service comprising:
one or more processors and;
one or more data storage devices which;
maintain a database of avatar descriptions and;
serves data files to a plurality of vehicles based on unique identifiers for the avatars.

4. The method of claim 3 where the service also provides approximations to avatars corresponding to the capabilities of the available display devices.

5. The method of claim 1 where the avatar is responsive to sensors on the vehicle indicating the presence of potential observers.

6. The method of claim 5 where the avatar responds in a unique manner to the presence of the user.

7. The method of claim 1 where the avatar contains information indicating the authenticated presence of a unique person or persons or goods within the vehicle.

8. A System comprising:
one or more reconfigurable displays positioned to be available external to a vehicle;
a data file containing information describing an avatar, the avatar representing a person, persons, or goods, which is selected or created by said person, persons, or the owner of the goods;
one or more computing devices in a vehicle configured to:
receive, from one or more remote computing devices, a message with movement instructions including a location where the vehicle is to proceed;
receive, from one or more computing devices, said data file describing an avatar associated with the person, persons, or goods for which the movement is being directed;
display on the reconfigurable displays the avatar or an approximation thereof; the approximation dependent on the display capabilities.

9. The system of claim 8 where the avatar consists of a two dimensional image and the display devices consist of two dimensional displays.

10. The system of claim 8 where the data file containing the description of an avatar is obtained from a system comprising:
one or more processors and;
one or more data storage devices which;
maintain a database of avatar descriptions and;
serves data files to a plurality of vehicles based on unique identifiers for the avatars.

11. The system of claim 10 where the service also provides approximations to avatars corresponding to the capabilities of the available display devices.

12. The system of claim 8 where the avatar is responsive to sensors on the vehicle indicating the presence of potential observers.

13. The system of claim 12 where the avatar responds in a unique manner to the presence of the user.

14. The system of claim 8 where the avatar contains information indicating the authenticated presence of a unique person or persons or goods within the vehicle.
